(19) United States
(12) Patent Application Publication
(10) Pub. No.: US 2026/0330373 A1
(43) Pub. Date: Oct. 22, 2026

(54) METHOD AND SYSTEM FOR PROVIDING A RISK ASSESSMENT AND EVALUATION FOR A SET OF ENTITIES

(71) Applicant: JPMorgan Chase Bank, N.A., New York, NY (US)

(72) Inventors: Hariharakrishnakumar V, Chennai (IN); Nitish KARTHIKEYAN, Kancheepuram (IN); Aayush R. NAYAK, Pune (IN)

(73) Assignee: JPMorgan Chase Bank, N.A., New York, NY (US)

(21) Appl. No.: 19/227,010

(22) Filed: Jun. 3, 2025

(30) Foreign Application Priority Data
Apr. 17, 2025 (IN) 202511037123

(51) Int. Cl. G06Q 10/0635

(52) U.S. Cl. CPC G06Q 10/0635

(57) ABSTRACT

A method and a system for providing a risk assessment and evaluation for a set of entities are disclosed. The method includes receiving an input dataset representing at least one corporate event associated with the set of entities from a data source. The method further includes identifying a plurality of risk parameters within the received input dataset. The method includes deriving a weight for each of the plurality of risk parameters using an entropy-weight computation module. Further, the method includes ranking each entity within the set of entities based on the derived weights. In addition, the method includes displaying a ranked list in the set of entities. Also, the method includes generating a summary for each of the plurality of risk parameters associated with each entity within the set of entities.

### CROSS-REFERENCE TO RELATED APPLICATIONS

This application claims priority benefit from Indian Application No. 202511037123, filed on Apr. 17, 2025, in the India Patent Office, which is hereby incorporated by reference in its entirety.

### FIELD OF THE DISCLOSURE

This technology generally relates to risk management, and more particularly relates to a method and a system for providing a risk assessment and evaluation for a set of entities.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In the dynamic business environment of corporate finance, companies regularly engage in corporate actions such as dividend issuance, bonus distribution, and share buybacks, each of which may have considerable financial and operational implications. While these actions are often integral to a company's (entity's) strategic goals, they inherently carry certain risks that, if not managed properly, may weaken the company's stability, financial health, and market standing. The effective assessment and management of these potential risks are crucial to ensure the long-term success and sustainability of a business. One of the primary challenges in corporate decision-making is the complexity of risk assessment associated with these corporate actions. The corporate actions involve a plurality of risk factors, including financial volatility, market conditions, regulatory shifts, and potential reactions from stakeholders. The difficulty in quantifying and comparing these risks often makes it challenging for individuals to obtain a clear understanding of certain consequences of their decisions. Moreover, traditional risk evaluation methods tend to rely on subjective judgment that may lead to potential biases and inconsistencies in corporate decision-making, further leading to flawed risk assessments.

Further, different stakeholders within a company or entity may have varying perspectives on the significance of certain risks. Thus, without incorporating inputs from diverse stakeholders, it is challenging to ensure that the risk assessment process is comprehensive and aligned with the company's overall strategic objectives.

Hence, in view of these and other existing limitations, there arises an imperative need to provide an efficient solution to overcome the above-mentioned limitations and to provide a method and system that assesses and evaluates the risks associated with corporate actions for various companies.

### SUMMARY

The present disclosure, through one or more of its various aspects, embodiments, and/or specific features or sub-components, provides, inter alia, various systems, servers, devices, methods, media, programs, and platforms for providing a risk assessment and evaluation for a set of entities.

According to an aspect of the present disclosure, a method for providing a risk assessment and evaluation for a set of entities is disclosed. The method is being implemented by at least one processor. The method includes receiving, by the at least one processor, an input dataset representing at least one corporate event associated with the set of entities from a data source. The method further includes identifying, by the at least one processor, a plurality of risk parameters within the received input dataset. The method includes deriving, by the at least one processor, a weight for each of the plurality of risk parameters using an entropy-weight computation module. Further, the method includes ranking, by the at least one processor, each entity within the set of entities based on the derived weights. In addition, the method includes displaying, by the at least one processor, a ranked list of the set of entities. Also, the method includes generating, by the at least one processor, a summary for each of the plurality of risk parameters associated with each entity within the set of entities.

In accordance with an exemplary embodiment, the input dataset may include a plurality of rows. Each row from the plurality of rows may define values corresponding to the plurality of risk parameters for an entity within the set of entities.

In accordance with an exemplary embodiment, each entity within the set of entities may correspond to a corporate entity.

In accordance with an exemplary embodiment, ranking the set of entities may include creating, by the at least one processor, a data matrix based on the values of the plurality of risk parameters and performing normalization on the data matrix to standardize values of the plurality of risk parameters. In addition, ranking the set of entities may include calculating, by the at least one processor, a weighted metric based on the standardized values for ranking the set of entities.

In accordance with an exemplary embodiment, ranking the set of entities may further include computing, by the at least one processor, a positive ideal matrix and a negative ideal matrix of the standardized values of the plurality of risk parameters, calculating, by the at least one processor, a distance of each entity within the set of entities from the positive ideal matrix, and calculating, by the at least one processor, a distance of each entity within the set of entries from the negative ideal matrix. The positive ideal matrix may depict a maximum value for each of the plurality of risk parameters. The negative ideal matrix may depict a minimum value for each of the plurality of risk parameters.

In accordance with an exemplary embodiment, ranking of the set of entities may further include computing, by the at least one processor, a pair of benchmark coordinates along with a performance score for each entity within the set of entities, determining, by the at least one processor, a final weight corresponding to each entity within the set of entities based on the pair of benchmark coordinates and the performance score for each entity within the set of entities, and ranking, by the at least one processor, each entity within the set of entities based on the determined final weight.

In accordance with an exemplary embodiment, the plurality of risk parameters may include at least one from among: numeric risk parameters, encoded non-numeric risk parameters, and derived risk parameters.

In accordance with an exemplary embodiment, the summary of the plurality of risk parameters may include a risk commentary for each entity in the ranked set of entities.

According to another aspect of the present disclosure, a computing device configured to implement an execution of a method for providing a risk assessment and evaluation for a set of entities is disclosed. The computing device includes a processor; a memory storing instructions; and a communication interface coupled to each of the processor and the memory. The processor may be programmed to cooperate with the instructions to perform operations including: receiving an input dataset representing at least one corporate event associated with the set of entities from a data source; identifying a plurality of risk parameters for the received input dataset; deriving a weight for each of the plurality of risk parameters using an entropy-weight computation module; ranking each entity within the set of entities based on the derived weight; displaying a ranked list of the set of entities; and generating a summary for each of the plurality of risk parameters associated with each entity within the set of entities.

In accordance with an exemplary embodiment, the input dataset may include a plurality of rows. Each row from the plurality of rows may define values corresponding to the plurality of risk parameters for an entity within the set of entities.

In accordance with an exemplary embodiment, each entity within the set of entities may correspond to a corporate entity.

In accordance with an exemplary embodiment, to rank the set of entities, the operations may further include: creating a data matrix based on the values of the plurality of risk parameters, performing normalization on the data matrix to standardize the values of the plurality of risk parameters; and calculating a weighted matrix based on the standardized values for ranking the set of entities.

In accordance with an exemplary embodiment, to rank the set of entities, the operations may further include: computing a positive ideal matrix and a negative ideal matrix of the standardized values of the plurality of risk parameters; calculating a distance of each entity within the set of entities from the positive ideal matrix; and calculating a distance of each entity within the set of entries from the negative ideal matrix. The positive ideal matrix may depict a maximum value for each of the plurality of risk parameters. The negative ideal matrix may depict a minimum value for each of the plurality of risk parameters.

In accordance with an exemplary embodiment, to rank of the set of entities, the operations may further include: computing a pair of benchmark coordinates along with a performance score for each entity within the set of entities; determining a final weight corresponding to each entity within the set of entities based on the pair of benchmark coordinates and the performance score for each entity within the set of entities; and ranking each entity within the set of entities based on the determined final weight.

In accordance with an exemplary embodiment, the plurality of risk parameters may include at least one from among: numeric risk parameters, encoded non-numeric risk parameters, and derived risk parameters.

In accordance with an exemplary embodiment, the summary of the plurality of risk parameters may include a risk commentary for each entity in the ranked set of entities.

According to yet another aspect of the present disclosure, a non-transitory computer-readable storage medium storing instructions for providing a risk assessment and evaluation for a set of entities is disclosed. The instructions include executable code which, when executed by a processor, may cause the processor to receive an input dataset representing at least one corporate event associated with the set of entities from a data source; identify a plurality of risk parameters within the received input dataset; derive a weight for each of the plurality of risk parameters using an entropy-weight computation module; rank each entity within the set of entities based on the derived weight; display a ranked list of the set of entities; and generate a summary for each of the plurality of risk parameters associated with each entity within the set of entities.

In accordance with an exemplary embodiment, the input dataset may include a plurality of rows. Each row from the plurality of rows may define values corresponding to the plurality of risk parameters for an entity within the set of entities.

In accordance with an exemplary embodiment, each entity within the set of entities may correspond to a corporate entity.

In accordance with an exemplary embodiment, to rank the set of entities, the operations further include: creating a data matrix based on the values of the plurality of risk parameters; performing normalization on the data matrix to standardize the values of the plurality of risk parameters; and calculating a weighted metric based on the standardized values for ranking the set of entities.

In accordance with an exemplary embodiment, to rank the set of entities, the operations further include: computing a positive ideal matrix and a negative ideal matrix of the standardized values of the plurality of risk parameters; calculating a distance of each entity within the set of entities from the positive ideal matrix; and calculating a distance of each entity within the set of entities from the negative ideal matrix. The positive ideal matrix may depict a maximum value for each of the plurality of risk parameters. The negative ideal matrix may depict a minimum value for each of the plurality of risk parameters.

In accordance with an exemplary embodiment, to rank the set of entities, the operations further include: computing a pair of benchmark coordinates along with a performance score for each entity within the set of entities; determining a final weight corresponding to each entity within the set of entities based on the pair of benchmark coordinates and the performance score for each entity within the set of entities and rank each entity within the set of entities based on the determined final weight.

In accordance with an exemplary embodiment, the plurality of risk parameters may include at least one from among: numeric risk parameters, encoded non-numeric risk parameters, and derived risk parameters.

In accordance with an exemplary embodiment, the summary of the plurality of risk parameters may include a risk commentary for each entity in the ranked set of entities.

### BRIEF DESCRIPTION OF THE DRAWINGS

The present disclosure is further described in the detailed description which follows, about the noted plurality of drawings, by way of non-limiting examples of exemplary embodiments of the present disclosure, in which characters represent like elements throughout the several views of the drawings.

FIG. 1 illustrates an exemplary system for providing a risk assessment and evaluation for a set of entities, in accordance with an exemplary embodiment of the present disclosure.

FIG. 2 illustrates an exemplary diagram of a network environment for providing a risk assessment and evaluation for the set of entities, in accordance with an exemplary embodiment of the present disclosure.

FIG. 3 illustrates an exemplary system for providing a risk assessment and evaluation for the set of entities, in accordance with an exemplary embodiment of the present disclosure.

FIG. 4 illustrates a process flow diagram for an exemplary system for providing a risk assessment and evaluation for the set of entities, in accordance with an exemplary embodiment of the present disclosure.

FIG. 5 illustrates an exemplary method flow diagram for providing a risk assessment and evaluation for the set of entities, in accordance with an exemplary embodiment of the present disclosure.

FIG. 6 illustrates a use case for visualization, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

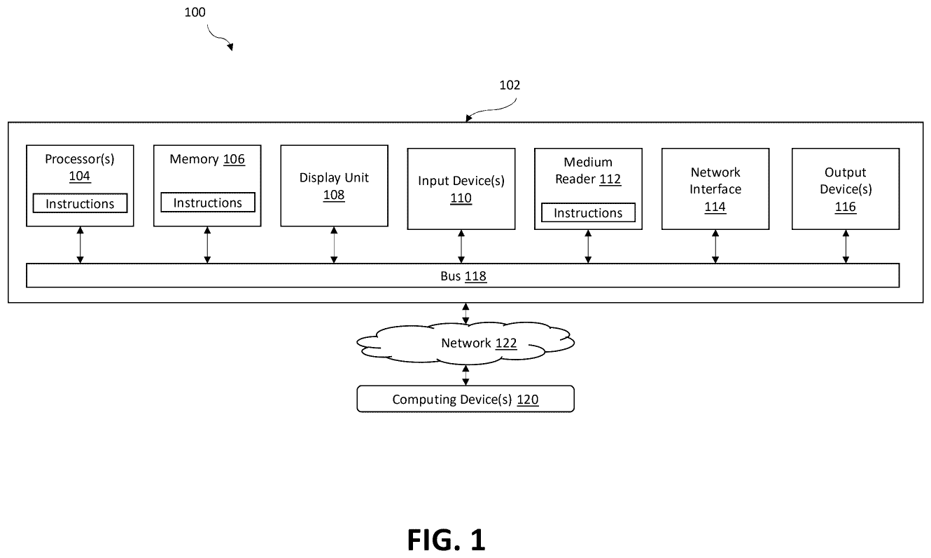

FIG. 1 illustrates an exemplary system 100 for providing a risk assessment and evaluation for a set of entities, in accordance with an exemplary embodiment of the present disclosure. The exemplary system 100 is generally shown and may include a computer system 102 which is generally indicated. The term “computer system” may also be referred to as “computing device” and such phrases/terms can be used interchangeably in the specification.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to provide a risk assessment and evaluation for the set of entities.

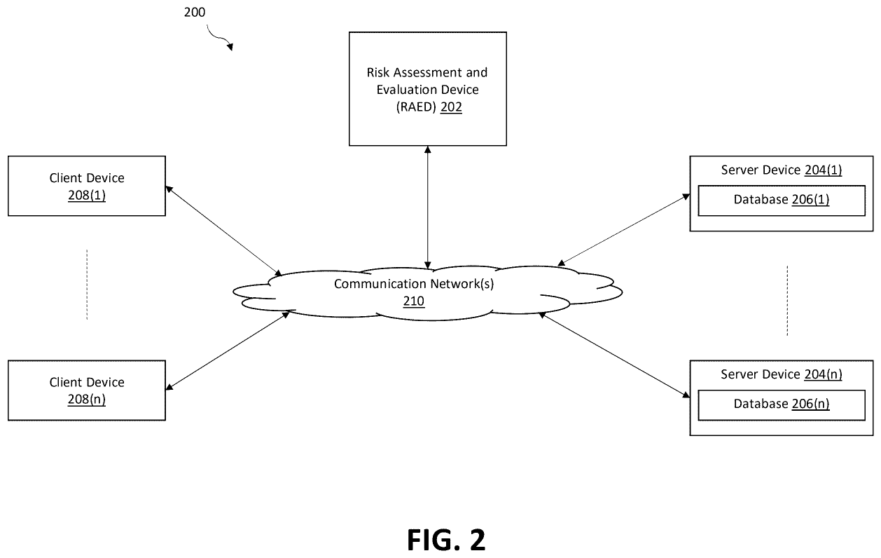

Referring to FIG. 2, a schematic diagram of an exemplary network environment 200 for providing a risk assessment and evaluation of a set of entities is illustrated. In an exemplary embodiment, the method is executable on any networked computer platform, such as, for example, a personal computer (PC).

The method providing a risk assessment and evaluation for the set of entities may be executed by a risk assessment and evaluation device (RAED) 202. The RAED 202 may be the same or similar to the computer system 102 as described with respect to FIG. 1. The RAED 202 may store one or more applications that may include executable instructions that, when executed by the RAED 202, cause the RAED 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Moreover, distributing large volumes of data associated with risk assessment and evaluation for a set of entities may also prove to be a key challenge for computing and information systems of any appreciable scale. The exemplary embodiments as disclosed herein may apply to a vast spectrum of applications that would benefit from low-latency delivery of large volumes of data to multiple data consumers. These embodiments may fundamentally address the practical problems of distributing such data over bandwidth-limited communication channels to compute-limited data consumers. This problem is particularly acute in connection with real-time data in risk assessment and evaluation. Real-time data distribution systems must contend with these physical limits when the real-time data rates exceed the ability of the communication channel to transfer the data and/or the ability of the data consumers to consume the data. Furthermore, the distribution of real-time financial market data to applications such as trading, risk monitoring, order routing, and matching engines represents one of the most demanding contemporary use cases.

In some embodiments, the processor 104 embedded within the RAED 202 as disclosed may be configured identify a plurality of risk parameters within received input dataset; derive a weight for each of the plurality of risk parameters using an entropy-weight computation module; rank each entity within the set of entities based on the derived weights; display a ranked list of the set of entities; generate a summary for each of the plurality of risk parameters associated with each entity within the set of entities so that the RAED 202 may receive input data from user to automatically complete a task associated with an entity based on the ranked list, thereby substantially reducing data latency among data transfer between components, modules, etc., within the RAED 202, reducing power consumption of overall system running within the RAED 202, reducing space consumption of the memory 106, improving data processing speed of the processor 104, etc., but the disclosure is not limited thereto.

While many of the exemplary embodiments discussed herein focus on applications in the financial markets, it should be understood that the technology described herein may be applied to a wide variety of other application domains.

In a non-limiting example, the application(s) may be operative in a cloud-based computing environment. The application(s) may be executed within or as a virtual machine(s) or virtual server(s) that may be managed in a cloud-based computing environment. Also, the application(s), and even the RAED 202 itself, may be located in the virtual server(s) running in a cloud-based computing environment rather than being tied to one or more specific physical network computing devices. Also, the application(s) may be running in one or more virtual machines (VMs) executing on the RAED 202. Additionally, in one or more embodiments of this technology, virtual machine(s) running on the RAED 202 may be managed or supervised by a hypervisor.

In the network environment 200 of FIG. 2, the RAED 202 is coupled to a plurality of server devices 204(1)-204(n) that hosts a plurality of databases 206(1)-206(n), and also to a plurality of client devices 208(1)-208(n) via communication network(s) 210. A communication interface of the RAED 202, such as the network interface 114 of the computer system 102 of FIG. 1, operatively couples and communicates between the RAED 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RAED 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and RAEDs that efficiently implement the method to provide a risk assessment and evaluation of a set of entities.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), public switched telephone networks (PSTNs), ethernet-based packet data networks (PDNs), combinations thereof, and the like.

The RAED 202 may be a standalone device or integrated with one or more other devices or apparatuses, such as one or more of the server devices 204(1)-204(n), for example. In a particular example, the RAED 202 may include or be hosted by one of the server devices 204(1)-204(n), and other arrangements are also possible. Moreover, one or more of the devices of the RAED 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the RAED 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store data related to the set of entities, etc.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computing device 120 as described with respect to FIG. 1, including any features or combination of features described with respect thereto. For example, the client devices 208(1)-208(n) in this example may include any type of computing device that can interact with the RAED 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the TCPD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the RAED 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the TCPD 202, the server devices 204(1)-204(n), or the client devices 208(1)-208(n), for example, may be configured to operate as virtual instances on the same physical machine. In other words, one or more of the RAED 202, the server devices 204(1)-204(n), or the client devices 208(1)-208(n) may operate on the same physical device rather than as separate devices communicating through communication network(s) 210. Additionally, there may be more or fewer RAEDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, packet data networks (PDNs), the Internet, intranets, and combinations thereof.

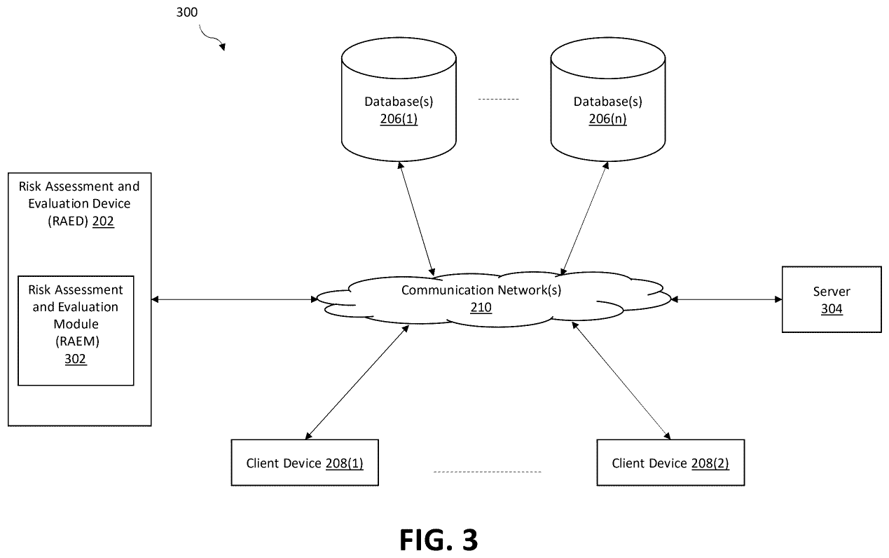

FIG. 3 illustrates an exemplary system 300 for providing a risk assessment and evaluation for a set of entities, in accordance with an exemplary embodiment. As illustrated in FIG. 3, according to exemplary embodiments, the system 300 may comprise a risk assessment and evaluation device (RAED) 202 including a risk assessment and evaluation module (RAEM) 302 that may be connected to a server device 204(1) and one or more repository from the repositories 206(1) . . . 206(n) via a communication network 210, but the disclosure is not limited thereto.

The RAED 202 as described and shown in FIG. 3 includes the RAEM 302, although it may include other rules, policies, modules, databases, or applications, for example. As will be described below, the RAEM 302 is configured to carry out a method to provide a risk assessment and evaluation of a set of entities.

An exemplary system 300 for enabling a mechanism to provide a risk assessment and evaluation of a set of entities of FIG. 2 is shown as being executed in FIG. 3. Specifically, a first client device 208(1) and a second client device 208(2) are illustrated as being in communication with the RAED 202. In this regard, the first client device 208(1) and the second client device 208(2) may be “clients” of the TCPD 202 and are described herein as such. Nevertheless, it is to be known and understood that the first client device 208(1) and/or the second client device 208(2) need not necessarily be “clients” of the RAED 202, or any entity described in association therewith herein. Any additional or alternative relationship may exist between either or both of the first client device 208(1) and the second client device 208(2) and the RAED 202, or no relationship may exist.

Further, the RAED 202 is illustrated as being able to access one or more repositories 206(1) . . . 206(n). The RAEM 302 may be configured to access these repositories/databases to provide a method to provide a risk assessment and evaluation of a set of entities.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the RAED 202 via broadband or cellular communication. These embodiments are merely exemplary and are not limiting or exhaustive.

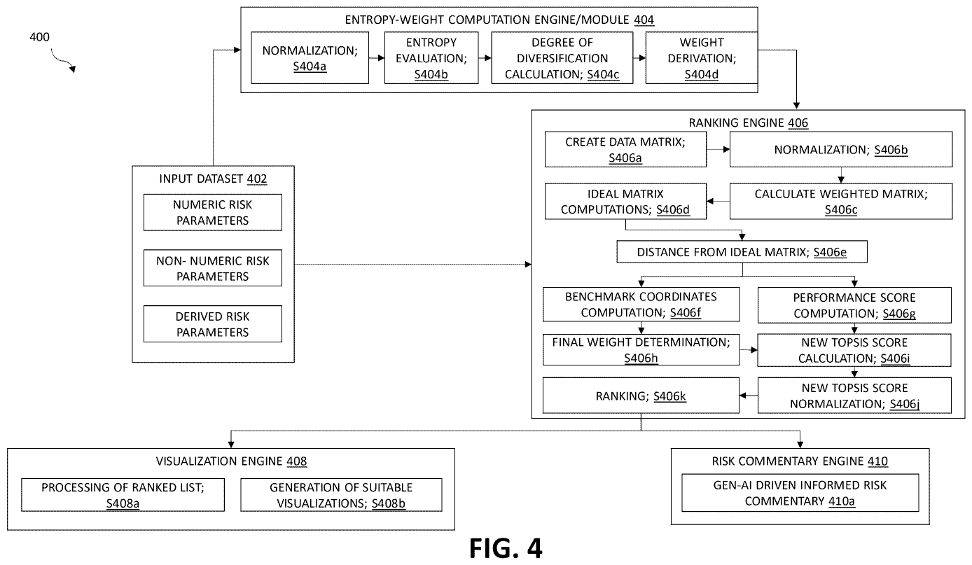

FIG. 4 illustrates a process flow diagram 400 for providing a risk assessment and evaluation for a set of entities, in accordance with an exemplary embodiment of the present disclosure. In an embodiment, each entity within the set of entities may correspond to a corporate entity or a company. The corporate entity may be a business corporation or a publicly listed company. In an example, the entity may be a company “ABC” listed on a stock exchange. Further, the set of entities may be a set of companies listed on a stock exchange or unlisted entities/companies that may be subject to the risk assessment and evaluation based on a plurality of risk parameters. In an example, the set of entities may also include other forms of market participants, such as government organizations, and non-profit organizations. In addition, the set of entities may further include, but are not limited to, the organizations or the companies as mentioned above, and may also correspond to investment funds, bonds, stocks, commodities, and the like.

The exemplary process flow 400 shows an input dataset 402, an entropy-weight computation engine/module 404, a ranking engine 406, a visualization engine 408, and a risk commentary engine 410. The input dataset 402 may be received from a data source such as but not limited to third-party databases, websites, financial data providers, and the like. The input dataset may represent at least one corporate event associated with the set of entities. The corporate event may include dividend issue, bonus issue, stock split, stock repurchase, and the like. The input dataset 402 may be associated with the plurality of risk parameters. The plurality of risk parameters may be identified within the received input dataset 402.

The plurality of risk parameters may comprise numeric risk parameters, encoded non-numeric risk parameters, and derived parameters. In an exemplary embodiment, numeric risk parameters, for example, may include an unresponded quantity, which in the context of stock market, refers to a portion of an order that is not yet executed by a stock market exchange. For example, if a trader places an order and does not receive confirmation from the stock market exchange, risk of the unresponded quantity may represent risk of uncertainty in execution of the order. Further, the encoded non-numeric risk parameters, for example, may include but not be limited to an exposure, which refers to an amount of capital or asset that is at risk in a trade or investment. The exposure represents potential loss an investor or trader may face due to market movements or any corporate event. The exposure may be encoded in the form of 0 or 1. If the exposure (potential loss) is more than a predefined threshold, the exposure is 1, else the exposure is 0. In an example, if a transaction amount exceeds one million dollars and corporate event type is a bonus issue, then the exposure parameter is assigned a value of one, otherwise, it is assigned a value of zero. The exposure may also have a value of “true” or “yes” which indicates that the exposure is significant and may require close monitoring and risk management. Further, the exposure may also have a value of “false” or “no” indicating that the exposure is negligible and may not require close monitoring.

The derived parameters, for example, may include an average exposure. In an embodiment, the average exposure may be measured in millions of USD for each investment account involved in the corporate event. The investment account may belong to at least traders, investors, or financial institutions participating in stock market transactions. The average exposure may be utilized in assessing level of risk or potential impact on individual accounts, allowing risk managers to prioritize the corporate events or communications based on magnitude of the average exposure. Further, the derived parameters, for example, may also include a deadline parameter. The deadline parameter may indicate whether a deadline for responding to or acting on the corporate event is less than a predefined threshold. A “true” or “yes” may suggest that the deadline is approaching quickly, necessitating prompt attention and action to ensure compliance and avoid any potential penalties or missed opportunities. In general, the deadline parameter may refer to a calculated risk factor that assesses time sensitivity of the corporate event based on predefined rules or conditions. For example, the deadline parameter may be derived using a logical condition applied to a dataset. If an entity's corporate event has a predefined execution deadline, such as a regulatory filing due date or a dividend payout schedule, the deadline parameter may be formulated based on the time remaining. For example, if a threshold is a predefined number of days (e.g. 7 days before the corporate event), indicating the corporate event is close to the deadline and may pose high risks due to time constraints.

The input dataset 402 may include a plurality of rows. Each row from the plurality of rows may define values corresponding to the plurality of risk parameters for an entity within the set of entities. The input dataset 402 along with the plurality of risk parameters may be transmitted to the entropy-weight computation engine/module 404. The entropy-weight computation engine 404 may be configured to derive weight for each of the plurality of risk parameters. In an implementation, the entropy-weight computation engine/module 404 may be an Artificial Intelligence (AI) based module. The entropy-weight computation engine 404 may perform a series of steps to derive weight for each of the plurality of risk parameters. At step S404a, the entropy-weight computation engine 404 may be configured to perform normalization of the input dataset 402. The input dataset 402 may be standardized to identify values of the plurality of risk parameters within a common scale. In an example, different risk parameters may have varying units and magnitudes, so, normalization ensures that no single parameter disproportionately influences the final ranking of the set of entities due to differences in scale. Further, normalization may be performed to maintain consistency in the input dataset 402 before proceeding for further computations. At step S404b, the entropy-weight computation engine 404 may be configured to perform entropy evaluation. Once the input dataset is normalized, the entropy-weight computation engine 404 may perform entropy evaluation to quantify amount of uncertainty or randomness associated with each risk parameter further associated with the entity within the set of entities.

In an exemplary embodiment, entropy may be a statistical measure that determines how much useful information a particular parameter provides in decision-making. A higher entropy value may indicate that a parameter contains significant uncertainty, meaning it may not contribute much to differentiation among the set of entities. Conversely, parameters with lower entropy values may be considered more informative as they provide greater distinction between entities. Based on the entropy evaluation, the entropy-weight computation engine 404 may determine relative importance of the plurality of risk parameters associated with the set of entities in ranking of the set of entities. At step S404c, the entropy-weight computation engine S404 may be configured to perform degree of diversification calculation. The degree of diversification may measure variability and spread of each risk parameter across the set of entities. A parameter with a high degree of diversification may indicate that the value of the parameter for an entity differs significantly among the set of entities, making it a crucial factor in ranking. Conversely, a parameter with low diversification may indicate minimal variation, which means low influence on the overall ranking of the set of entities.

At step S404d, the entropy-weight computation engine 404 may be configured to perform weight derivation for each of the plurality of risk parameters associated with the set of entities. The entropy-weight computation engine 404 may derive weight for each risk parameter based on the computed entropy values and diversification scores. In an example, parameters with greater diversification may receive higher weights, as they may deem to be more influential in distinguishing the set of entities. The derived weights may then be transmitted to the ranking engine 406 where the derived weights are used in a TOPSIS-based ranking computation.

The entropy-weight computation engine/module 404 may be in communication with the ranking engine 406. The ranking engine 406 may utilize Technique for Order Performance by Similarity to Ideal Solution (TOPSIS) to perform ranking of each entity within the set of entities based on derived weight. The entropy-weight computation engine/module 404 may provide the derived weight for each entity within the set of entities to the ranking engine 406.

In an exemplary implementation, consider a scenario where a company evaluates three investment options (A, B, and C) based on three risk parameters: market volatility, regulatory risk, and liquidity impact. First, in normalization (S404a), raw values of these parameters may be scaled to ensure consistency. Next, in entropy evaluation (S404b), the entropy-weight computation engine 404 may calculate how much uncertainty each parameter introduces; for instance, if market volatility fluctuates significantly, it has high entropy. Then, in degree of diversification calculation (S404c), the entropy-weight computation engine 404 may determine which parameters contribute the most variation. Let us say, liquidity impact shows the most difference among options, making it highly informative. Finally, in weight derivation (S404d), weights may be derived based on importance, with liquidity impact getting the highest weight, followed by regulatory risk, and market volatility receiving the least. These weights may help rank the investment options using TOPSIS algorithm. As is known in the art, TOPSIS is a multi-criteria decision-making method that ranks alternatives based on their distance from an ideal solution.

In an exemplary implementation, the derived weights may be transmitted to the ranking engine 406. Based on the derived weights, the ranking engine 406 may perform a series of steps to facilitate ranking of the set of entities. In an exemplary embodiment, at step S406a, to rank each entity within the set of entities, the ranking engine 406 may be configured to create a data matrix based on the values of the plurality of risk parameters. The data matrix may include a plurality of rows, and a plurality of columns, where each row may represent a corporate event (e.g., a dividend declaration, bonus issue, or stock split), and each column may represent a specific risk parameter associated with the corporate events. In an example, three corporate events (such as A: dividend issuance, B: bonus issue, C: stock split) may be evaluated based on risk parameters such as high exposure, deadline approaching to take an action, and unresponded quantity.

Further, at step S406b, the ranking engine 406 may be configured to perform normalization on the created data matrix to standardize values of the plurality of risk parameters. The table below is an exemplary illustration to show standardized values for the risk parameters as described above:

| | Unresponded | Deadlines less | Exposure (Risk |
|---|---|---|---|
| Corporate Event | quantity | than 7 days | score) |
| Dividend issuance | 0 | 0 | 90 |
| Bonus issue | 1 | 1 | 85 |

In the above table, unresponded quantity may specify whether there is a pending execution of an order related to the event. A value of 0 indicates an unexecuted portion, while 1 means no unresponded quantity.

For a deadline less than 7 days, a value of 0 may suggest that the deadline is within a week, whereas a value of 1 may mean it is beyond that time frame. In addition, the deadline less than 7 days may also indicate an urgency, where a value of 0 may indicate urgency and a value of 1 may indicate no urgency.

A numerical value representing the level of exposure risk may be associated with the corporate event. A higher score (e.g., 90 for Dividend Issuance) may suggest a higher exposure compared to lower values (75 for Stock Split).

As illustrated in the above table, dividend issuance has an unresponded quantity 0, and since deadline less than 7 days is marked as 0 (which means deadline is near), the dividend issuance event becomes urgent and action needs to be taken urgently, hence it has the highest risk exposure i.e., 90.

Similarly, as illustrated in the above table, bonus issue has unresponded quantity 1, and deadline less than 7 days is marked as 1, indicating less or no urgency, hence exposure score is 85, which is lower than dividend issuance.

Also, the ranking engine 406, at step S406c, may be configured to calculate a weighted matrix based on the standardized values for ranking of the set of entities.

In an exemplary embodiment, the ranking engine 406, at step S406d, may be configured to compute a positive ideal matrix and a negative ideal matrix of the standardized values of the plurality of risk parameters. For example, while evaluating three corporate events such as dividend issuance, bonus issue and stock split based on risk parameters such as exposure, deadline, the positive ideal matrix may include low values observed across all the risk parameters. Conversely, the negative ideal matrix may include high values across all the risk parameters.

Further, the ranking engine 406, at step S406e, may be configured to calculate a distance of each entity within the set of entities from the positive ideal matrix. The positive ideal matrix may depict a maximum value for each of the plurality of risk parameters. Also, the ranking engine 406, at step S406e, may be configured to calculate a distance of each entity within the set of entities from the negative ideal matrix. The negative ideal matrix may depict a minimum value for each of the plurality of risk parameters.

In an exemplary embodiment, the ranking engine 406, at step S406f, may be configured to compute a pair of benchmark coordinates along with a performance score, at step S406g, for each entity within the set of entities. In an example, the pair of benchmark coordinates may be computed based on the distance of each entity within the set of entities from the positive ideal matrix and the distance of each entity within the set of entities from the negative ideal matrix. Further, the ranking engine 406, at step S406h, may be configured to determine a final weight corresponding to each entity within the set of entities based on the pair of benchmark coordinates and a performance score for each entity within the set of entities. At step S406i, the ranking engine 406 may be configured to calculate new TOPSIS score based on the determined final weight and the performance score. Further, at step S406j, the ranking engine 406 may perform normalization on the new TOPISIS score. The new TOPSIS score may be calculated to refine the initial performance scores. For example, some corporate events may receive nearly identical initial performance scores because of similar risk parameter values (e.g., two bonus issues with nearly the same financial impact). The new TOPSIS score may ensure that even small variations in financial impact are correctly reflected. Furthermore, based on the normalized new TOPSIS score, the ranking engine 406, at step S406k, may be configured to rank each entity within the set of entities based on the determined final weight corresponding to each entity within the set of entities and the normalized new TOPSIS score.

Further, the ranking engine 406 may send a ranked list of the set of entities to the visualization engine 408 and the risk commentary engine 410. The ranked list of the set of entities may be displayed on a communication device. The communication device may be a mobile phone, laptop, computer, palmtop, and the like. In an example, the communication device may be associated with a user such as a trader, an investor, and the like. The visualization engine 408 may perform one or more steps to display the ranked list of the set of entities. The visualization engine 408, at step S408a, may be configured to process the ranked list of the set of entities. Further, the visualization engine 408, at step S408b, may be configured to generate suitable visualizations to display the ranked list. The suitable visualizations may be graphical representations, charts, tables, and the like. The suitable visualizations may make analysis of the ranked list easy for traders, investors, and other stakeholders.

The risk commentary engine 410 may be configured to generate a summary for each of the plurality of risk parameters associated with each entity within the set of entities. The risk commentary may be generated for each entity in the ranked list of the set of entities. In an example, the summary may include Generative-Artificial Intelligence (Gen-AI) driven informed risk commentary 410a. The risk commentary engine 410 uses Generative AI (Gen-AI) models to interpret numerical rankings and convert them into human-readable summaries, enabling traders, investors, and decision-makers to understand the significance of each ranked entity. The generated commentary may highlight key insights, such as: risk level associated with a particular corporate event for the set of entities, financial exposure, and potential implications of each corporate event for the set of entities, and recommended course of action based on ranking.

In an exemplary implementation, consider a scenario where three entities (Entity A, Entity B, Entity C) are ranked based on the risk parameters such as financial impact, deadline urgency and profitability.
Entity A—High financial exposure, deadline in 3 days, moderate profitability.
Entity B—Moderate financial exposure, deadline in 10 days, high profitability.
Entity C—Low financial exposure, deadline in 5 days, moderate profitability.

After the ranking engine 406 processes this data, the risk commentary engine 410 may generate the summary for each entity. The Gen-AI-based commentary may provide insights like: “Entity A ranks the highest due to its high financial exposure and an imminent deadline of 3 days. Given its critical nature, immediate attention is required to mitigate financial risks. Delays in addressing associated risks may lead to significant market impact and regulatory concerns. Prioritization of risk mitigation strategies is strongly recommended.”, “Entity B is ranked second due to its moderate financial exposure and high profitability potential. With a deadline of 10 days, there is adequate time for risk assessment and mitigation planning. The entity presents a valuable investment opportunity, but timely evaluation is necessary to maximize profitability while managing associated risks.”, “Entity C ranks the lowest due to its low financial exposure and moderate profitability. The deadline of 5 days allows for routine risk assessment without immediate intervention. While this entity remains relevant, it does not pose an urgent risk and can be addressed after higher-priority entities.”

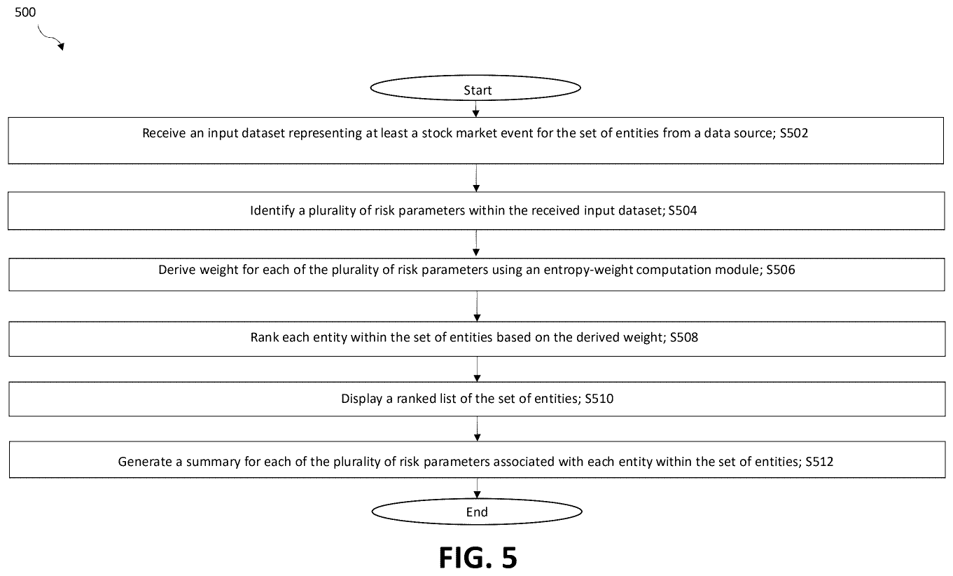

Referring to FIG. 5, an exemplary method 500 is shown for providing a risk assessment and evaluation for a set of entities, in accordance with an exemplary embodiment. Each entity within the set of entities may correspond to a corporate entity or a company. The corporate entity may be a business corporation or a publicly listed company. In an example, the entity may be a company “ABC” listed on a stock exchange. In an exemplary embodiment, the set of entities may correspond to a plurality of corporate entities or businesses. Further, the set of entities may be a set of companies listed on a stock exchange or unlisted entities/companies that may subject to the risk assessment and evaluation based on a plurality of risk parameters. In an example, the set of entities may also include other forms of market participants, such as governmental organizations, and non-profit organizations. In addition, the set of entities further include, but are not limited to, the organizations or companies as mentioned above, and may also correspond to investment funds, bonds, stocks, commodities, and the like.

As shown in FIG. 5, the method 500 begins following a need to provide a risk assessment and evaluation for the set of entities. The method 500 is implemented by at least one processor 104. In an implementation, the method 500 may be performed by an exemplary system (herein after system) that may be a computing device 100 of FIG. 1.

At step S502, the method 500 may include receiving an input dataset representing at least a corporate event for the set of entities from a data source. The input dataset 402 may be associated with a plurality of risk parameters.

At step S504, the method 500 may include identifying the plurality of risk parameters for the received input dataset. The plurality of risk parameters may include numeric risk parameters, encoded non-numeric risk parameters, and derived parameters. In an exemplary embodiment, numeric risk parameters may include, for example, an unresponded quantity. In an exemplary implementation, the unresponded quantity, in the context of stock market, may refer to a portion of an order that is not yet executed by a stock market exchange. For example, if a trader places an order and does not receive confirmation from the stock market exchange, risk of the unresponded quantity may represent risk of uncertainty in execution of the order. Further, the encoded non-numeric risk parameters may include, for example, an exposure. In an exemplary implementation, the exposure may refer to an amount of capital or assets that are at risk in a trade or investment. The exposure may represent potential loss an investor or trader may face due to market movements or any corporate event. The exposure may be encoded in the form of 0 or 1. If the exposure (potential loss) is more than a predefined threshold, the exposure is 1, else the exposure is 0. In an example, if a transaction amount exceeds one million dollars and corporate event type is a bonus issue, then the “exposure” parameter is assigned a value of one, otherwise, it is assigned a value of zero. The exposure may also have a value of “true” or “yes” which may indicate that the exposure is significant and may require close monitoring and risk management. Further, the exposure may also have a value of “false” or “no” indicating that the exposure may be negligible and may not require close monitoring.

The derived parameters may include, for example, an average exposure. In an embodiment, the average exposure may be measured in millions of USD for each account involved in the corporate event. The average exposure may be utilized in assessing level of risk or potential impact on individual accounts, allowing risk managers to prioritize the corporate events or communications based on magnitude of the average exposure. Further, the derived parameters include a deadline parameter. The deadline parameter may indicate whether a deadline for responding to or acting on the corporate event is less than a predefined threshold. A “true” or “yes” would suggest that the deadline is approaching quickly, necessitating prompt attention and action to ensure compliance and avoid any potential penalties or missed opportunities. In general, the deadline parameter may refer to a calculated risk factor that assesses the time sensitivity of the corporate event based on predefined rules or conditions. For example, the deadline parameter may be derived using a logical condition applied to a dataset. If an entity's corporate event has a predefined execution deadline, such as a regulatory filing due date or a dividend payout schedule, the deadline parameter may be formulated based on the time remaining. For example, if a threshold is a predefined number of days (e.g. 7 days before the corporate event), indicating the corporate events close to the deadline pose high risks due to time constraints. The input dataset 402 may include a plurality of rows. Each row from the plurality of rows may define values corresponding to the plurality of risk parameters for an entity within the set of entities. The input dataset 402 along with the plurality of risk parameters may be transmitted to an entropy-weight computation engine/module 404.

At step S506, the method 500 may derive weight for each of the plurality of risk parameters using the entropy-weight computation module 404 as shown with respect to FIG. 4. The entropy-weight computation engine 404 may perform a series of steps to derive weight for each of the plurality of risk parameters (as explained in FIG. 4).

At step S508, the method 500 may include ranking each entity within the set of entities based on the derived weight. For ranking, the method 500 may further include creating a data matrix based on values of the plurality of risk parameters, performing normalization on the data matrix to standardize values of the plurality of risk parameters, and calculating a weighted matrix based on the standardized values for ranking the set of entities. Further, the method 500 may include computing a positive ideal matrix and a negative ideal matrix of the standardized values of the plurality of risk parameters; calculating a distance of each entity within the set of entities from the positive ideal matrix; and calculating a distance of each entity within the set of entities from the negative ideal matrix (as explained in FIG. 4).

At step S510, the method 500 may include displaying a ranked list of the set of entities. For example, consider a scenario where three entities (Entity A, Entity B, Entity C) are ranked based on the risk parameters such as, financial impact, deadline urgency and profitability. Entity A has high financial exposure, deadline in 3 days, moderate profitability. Entity B has moderate financial exposure, deadline in 10 days, high profitability. Entity C has low financial exposure, deadline in 5 days, moderate profitability. Hence, in the ranked list, Entity A is ranked highest the highest due to its high financial exposure, Entity A is ranked second due to its moderate financial exposure and high profitability, and Entity C is ranked lowest in the ranked list.

At step S512, the method 500 may include generating a summary for each of the plurality of risk parameters associated with each entity within the set of entities. The summary of the plurality of risk parameters may comprise a risk commentary for each entity in the ranked list of the set of entities. In an example, the risk commentary for the three entities based on the above listed risk parameters may be as follows: “Entity A ranks the highest due to its high financial exposure and an imminent deadline of 3 days. Given its critical nature, immediate attention is required to mitigate financial risks. Delays in addressing associated risks may lead to significant market impact and regulatory concerns. Prioritization of risk mitigation strategies is strongly recommended.”, “Entity B is ranked second due to its moderate financial exposure and high profitability potential. With a deadline of 10 days, there is adequate time for risk assessment and mitigation planning. The entity presents a valuable investment opportunity, but timely evaluation is necessary to maximize profitability while managing associated risks.”, “Entity C ranks the lowest due to its low financial exposure and moderate profitability. The deadline of 5 days allows for routine risk assessment without immediate intervention. While this entity remains relevant, it does not pose an urgent risk and can be addressed after higher-priority entities.”

The method 500 terminates after performing step S512.

It will be appreciated by the person skilled in the art that the disclosed method offers an intelligent solution for providing the risk assessment and evaluation for a set of entities.

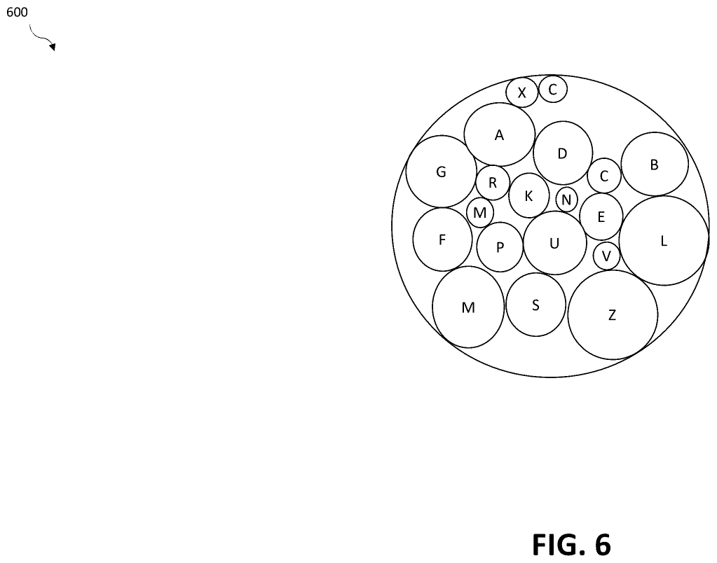

FIG. 6 illustrates an exemplary visualization 600 of a set of entities based on a ranked list, in accordance with an embodiment of the present disclosure. The visualization 600 may be generated by a visualization engine 408 (shown and explained in FIG. 4). The visualization 600 shows the set of entities as A, B, C, etc. shown in different sizes of circles. The size of the circle in the visualization 600 may represent an average TOPSIS score for a given entity. A larger circle may denote a higher average score and may help identify the entities from the set of entities which have the most critical events associated. The texture in the circles may represent “Days left for Deadline” for a given corporate event. In an example, this may be a representation of the number of days left for position-holders to respond. The circle that has a more filled texture as compared to the circle that has less filled texture may suggest that the deadline is approaching.

Using this visualization 600, risk managers may see a dynamic, day-to-day view of upcoming response deadlines while also having an idea of which entities within the set of entities have critical corporate events. This may boost the strategizing and planning capabilities of risk managers.

The present disclosure provides several advantages as given below. The invention described herein addresses these challenges by providing a system and method that enables users to objectively assess and prioritize the risks associated with corporate events for the set of entities. The system may offer a systematic, data-driven, and stakeholder-aligned approach to risk evaluation, helping individuals or firms to make informed decisions while balancing potential opportunities with inherent risks. By leveraging this system and method, companies may enhance their resource allocation strategies, ensure that their risk management efforts are focused on the most risky events, and ultimately safeguard their financial stability and market success.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for providing a risk assessment and evaluation for a set of entities is disclosed. The instructions include executable code which, when executed by a processor, may cause the processor to perform operations including: receiving an input dataset representing at least a stock market event for the set of entities from a data source; identify a plurality of risk parameters for the received input dataset; deriving weight for each of the plurality of risk parameters using an entropy-weight computation module; ranking each entity within the set of entities based on the derived weight; displaying a ranked list of the set of entities; and generating a summary for each of the plurality of risk parameters associated with each entity within the set of entities.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for providing a risk assessment and evaluation for a set of entities, the method being implemented by at least one processor, the method comprising:
receiving, by the at least one processor, an input dataset representing at least one corporate event associated with the set of entities from a data source;
identifying, by the at least one processor, a plurality of risk parameters within the received input dataset;
deriving, by the at least one processor, a weight for each of the plurality of risk parameters using an entropy-weight computation module;
ranking, by the at least one processor, each entity within the set of entities based on the derived weight;
displaying, by the at least one processor, a ranked list of the set of entities; and
generating, by the at least one processor, a summary for each of the plurality of risk parameters associated with each entity within the set of entities.

2. The method as claimed in claim 1, wherein the input dataset comprises a plurality of rows, wherein each row from the plurality of rows defines values corresponding to the plurality of risk parameters for an entity within the set of entities.

3. The method as claimed in claim 1, wherein each entity within the set of entities corresponds to a corporate entity.

4. The method as claimed in claim 2, wherein ranking the set of entities comprises:
creating, by the at least one processor, a data matrix based on the values of the plurality of risk parameters;
performing, by the at least one processor, normalization on the data matrix to standardize the values of the plurality of risk parameters; and
calculating, by the at least one processor, a weighted matrix based on the standardized values for ranking the set of entities.

5. The method as claimed in claim 4, wherein ranking of the set of entities further comprises:
computing, by the at least one processor, a positive ideal matrix and a negative ideal matrix of the standardized values of the plurality of risk parameters;
calculating, by the at least one processor, a distance of each entity within the set of entities from the positive ideal matrix, wherein the positive ideal matrix depicts a maximum value for each of the plurality of risk parameters; and
calculating, by the at least one processor, a distance of each entity within the set of entities from the negative ideal matrix, wherein the negative ideal matrix depicts a minimum value for each of the plurality of risk parameters.

6. The method as claimed in claim 5, wherein ranking the set of entities further comprises:
computing, by the at least one processor, a pair of benchmark coordinates along with a performance score for each entity within the set of entities;
determining, by the at least one processor, a final weight corresponding to each entity within the set of entities based on the pair of benchmark coordinates and the performance score for each entity; and
ranking, by the at least one processor, each entity within the set of entities based on the determined final weight.

7. The method as claimed in claim 1, wherein the plurality of risk parameters comprises at least one from among numeric risk parameters, encoded non-numeric risk parameters, and derived risk parameters.

8. The method as claimed in claim 1, wherein the summary of the plurality of risk parameters comprises a risk commentary for each entity in the ranked list of the set of entities.

9. A computing device configured to provide a risk assessment and evaluation for a set of entities, the computing device comprising:
a processor,
a memory storing instructions; and
a communication interface coupled to each of the processor and the memory,
wherein the processor is programmed to cooperate with the instructions to perform operations comprising:
receiving an input dataset representing at least one corporate event associated with the set of entities from a data source;
identifying a plurality of risk parameters within the received input dataset;
deriving a weight for each of the plurality of risk parameters using an entropy-weight computation module;
ranking each entity within the set of entities based on the derived weight;
display a ranked list of the set of entities; and
generating a summary for each of the plurality of risk parameters associated with each entity within the set of entities.

10. The computing device as claimed in claim 9, wherein the input dataset comprises a plurality of rows, wherein each row from the plurality of rows defines values corresponding to the plurality of risk parameters for an entity within the set of entities.

11. The computing device as claimed in claim 9, wherein each entity within the set of entities corresponds to a corporate entity.

12. The computing device as claimed in claim 9, wherein to rank the set of entities, the operations further comprise:
creating a data matrix based on the values of the plurality of risk parameters;
performing normalization on the data matrix to standardize the values of the plurality of risk parameters; and
calculating a weighted matrix based on the standardized values for ranking the set of entities.

13. The computing device as claimed in claim 12, wherein to rank the set of entities, the operations further comprise:
computing a positive ideal matrix and a negative ideal matrix of the standardized values of the plurality of risk parameters;
calculating a distance of each entity within the set of entities from the positive ideal matrix, wherein the positive ideal matrix depicts a maximum value for each of the plurality of risk parameters; and
calculating a distance of each entity within the set of entities from the negative ideal matrix, wherein the negative ideal matrix depicts a minimum value for each of the plurality of risk parameters.

14. The computing device as claimed in claim 12, wherein to rank the set of entities, the operations further comprise:
computing a pair of benchmark coordinates along with a performance score for each entity within the set of entities;
determining a final weight corresponding to each entity within the set of entities based on the pair of benchmark coordinates and the performance score for each entity; and
ranking each entity within the set of entities based on the determined final weight.

15. The computing device as claimed in claim 9, wherein the plurality of risk parameters comprises at least one from among: numeric risk parameters, encoded non-numeric risk parameters, and derived risk parameters.

16. The computing device as claimed in claim 9, wherein the summary of the plurality of risk parameters comprises a risk commentary for each entity in the ranked list of the set of entities.

17. A non-transitory computer readable storage medium storing instruction for providing a risk assessment and evaluation for a set of entities, the instructions comprising executable code which when executed by a processor, causes the processor to perform operations comprising:
receiving, an input dataset representing at least one corporate event associated with the set of entities from a data source;
identifying, a plurality of risk parameters within the received input dataset;
deriving, a weight for each of the plurality of risk parameters using an entropy-weight computation module;
ranking, each entity within the set of entities based on the derived weight;
displaying, a ranked list of the set of entities; and
generating, a summary for each of the plurality of risk parameters associated with each entity within the set of entities.

18. The non-transitory computer readable storage medium as claimed in claim 17, wherein the input dataset comprises a plurality of rows, wherein each row from the plurality of rows defines values corresponding to the plurality of risk parameters for an entity within the set of entities.

19. The non-transitory computer readable storage medium as claimed in claim 17, wherein ranking the set of entities comprises:
creating, a data matrix based on the values of the plurality of risk parameters;
performing, normalization on the data matrix to standardize the values of the plurality of risk parameters; and
calculating, a weighted matrix based on the standardized values for ranking the set of entities;
computing, a pair of benchmark coordinates along with a performance score for each entity within the set of entities;
determining, a final weight corresponding to each entity within the set of entities based on the pair of benchmark coordinates and the performance score for each entity; and
ranking, each entity within the set of entities based on the determined final weight.

20. The non-transitory computer readable storage medium as claimed in claim 17, wherein the summary of the plurality of risk parameters comprises a risk commentary for each entity in the ranked list of the set of entities.
